(19) United States
(12) Patent Application Publication
(10) Pub. No.: US 2026/0051520 A1
(43) Pub. Date: Feb. 19, 2026

(54) FUEL CELL HYDROGEN GAS MITIGATION

(71) Applicant: FORD GLOBAL TECHNOLOGIES, LLC, Dearborn, MI (US)

(72) Inventors: William Frederick SANDERSON, JR., Commerce Township, MI (US); Valentina MEJIA MEJIA, Royal Oak, MI (US)

(21) Appl. No.: 18/802,788

(22) Filed: Aug. 13, 2024

(51) Int. Cl. H01M 8/04746; H01M 8/04082; H01M 8/04223; H01M 8/04225; H01M 8/04302; H01M 8/04537

(52) U.S. Cl. CPC H01M 8/04753; H01M 8/04201; H01M 8/04225; H01M 8/04231; H01M 8/04302; H01M 8/04552; H01M 2250/20

(57) ABSTRACT

A fuel cell includes an anode, a cathode, and a membrane separating the anode and the cathode. A controller, responsive to expiration of a predetermined time period that begins with disconnection of the fuel cell from an electrical bus, injects hydrogen gas into the anode and purges the cathode of oxygen.

### TECHNICAL FIELD

This disclosure relates to hydrogen gas mitigation in fuel cells.

### BACKGROUND

Systems requiring hydrogen gas mitigation are used in various industrial applications. Proper management of hydrogen gas levels maintains system integrity and functionality, particularly during extended periods of inactivity, known as soak durations. Traditionally, manual intervention has been required to start up and shut down such systems, to ensure appropriate hydrogen gas levels are maintained.

### SUMMARY

An automotive fuel system includes a fuel cell with an anode, a cathode, and a membrane separating the anode and the cathode, and a controller. The controller, responsive to expiration of a predetermined time period that begins with disconnection of the fuel cell from an electrical bus, injects hydrogen gas into the anode and purges the cathode of oxygen. The controller may further monitor a voltage of the fuel cell during hydrogen gas injection and oxygen purge. The controller may terminate the hydrogen gas injection and oxygen purge when the voltage reaches a predetermined threshold. The controller may perform the hydrogen gas injection and oxygen purge without a contactor to connect the fuel cell to the electrical bus engaged. The predetermined time period may be based on an estimated hydrogen gas depletion rate of the fuel cell. In some configurations, a hydrogen gas storage system is connected to the anode for supplying hydrogen gas. In other embodiments, there may be an air compressor connected to the cathode for purging oxygen.

A method for mitigation in a fuel cell system includes injecting an inactive fuel cell system with hydrogen gas when a time duration since fuel cell system inactivation exceeds a threshold time for hydrogen gas depletion across the fuel cell system, and depleting oxygen from the fuel cell system. In some configurations, the method may include monitoring a voltage of the fuel cell system during injection of the hydrogen gas and oxygen depletion and terminating injection of the hydrogen gas and oxygen depletion when the voltage reaches a predetermined threshold. The threshold time may be determined based on operating conditions of the fuel cell system prior to inactivation. The method may be performed periodically while the fuel cell system remains inactive for an extended period. The injected hydrogen gas may be provided from a hydrogen gas storage system connected to the fuel cell system.

A method for preserving electrochemical cell performance includes administering hydrogen gas to an inactive electrochemical cell anode when an elapsed time since deactivation of the electrochemical cell surpasses a predefined hydrogen gas depletion threshold, thereby reactivating the electrochemical cell, and removing oxygen from the electrochemical cell to initiate an inactive state and reduce residual voltage for subsequent reactivation of the electrochemical cell. In some configurations, the method may include monitoring a voltage of the electrochemical cell during administration of the hydrogen gas and oxygen removal and terminating the administration of the hydrogen gas and oxygen removal when the voltage reaches a predetermined threshold. The predefined hydrogen gas depletion threshold may be based on operating conditions of the electrochemical cell prior to deactivation. The method may be performed without connecting the electrochemical cell to an external load. Hydrogen gas administration and oxygen removal may be performed using a controller programmed to initiate these actions based on the elapsed time since deactivation.

### BRIEF DESCRIPTION OF THE DRAWINGS

FIG. 1 is a schematic diagram of a traditional hydrogen gas mitigation system;

FIG. 2 is a schematic diagram of a fuel cell system;

FIG. 3 is a schematic diagram of a hydrogen gas mitigation system;

FIG. 4 is a process diagram of hydrogen gas mitigation; and

FIG. 5 is a flowchart of hydrogen mitigation.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Hydrogen gas (H₂) protection is an aspect of fuel cell technology, particularly for systems such as vehicles that may experience extended periods of inactivity. The hydrogen protection process involves maintaining a hydrogen-rich environment within the fuel cell stack, effectively “blanketing” both the anode and cathode. The primary purpose of this H₂ protection is to prevent catalyst degradation, which may affect the fuel cell's performance.

In the context of fuel cell powered vehicles, this protective measure allows for long soaks during periods when the vehicle remains inactive. Current technology has not effectively demonstrated the capability to maintain effective H₂ protection for up to 90 hours or more. If a vehicle remains inactive for a 90-hour duration or beyond this threshold, the hydrogen protection may be compromised. In such cases, when the fuel cell stack is restarted, it would undergo an “air/air start-up.” This situation exposes both the anode and cathode to air, which may lead to faster degradation of the catalyst materials.

The effectiveness of hydrogen protection is heavily dependent on the shutdown (SD) process, particularly the oxygen depletion SD that occurs when the vehicle is turned off. If this process is executed correctly, it sets the stage for the extended protection period. However, if the oxygen depletion SD does not occur properly, the hydrogen protection might only last for a matter of minutes, leaving the fuel cell stack vulnerable to rapid degradation.

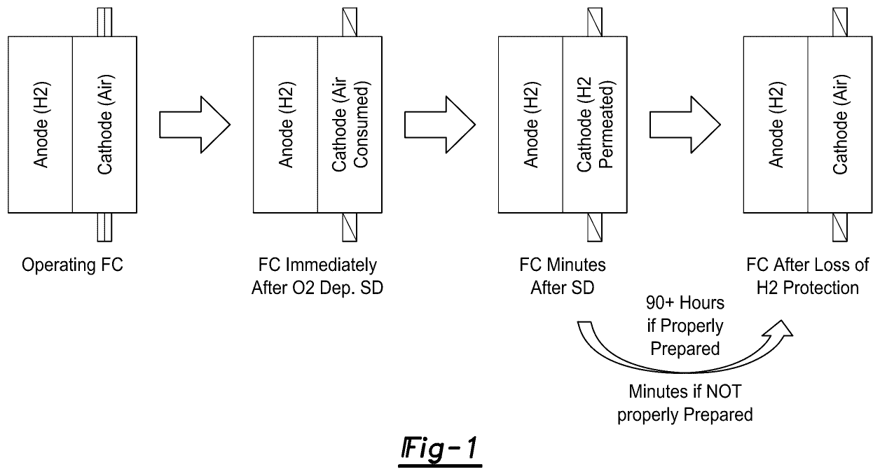

FIG. 1 shows the stages of a traditional fuel cell (FC) system's operation and SD process. During “Operating FC” a FC has two compartments an anode labeled “Anode H₂”, and a cathode labeled “Cathode Air”. During normal operation, these compartments only exchange protons across a selective membrane between the anode and the cathode. “FC immediately after O₂ Dep.SD” shows the FC after an oxygen depletion SD. After SD, the oxygen is consumed while the anode remains filled with H₂. The “FC minutes after SD” shows the H₂ within both the anode and the cathode for proper storage to prevent catalyst degradation. If the FC is properly prepared it may remain inactive for a longer duration, however if it is not prepared catalyst degradation may start within minutes of SD. In “FC after loss of H₂ Protection” both the anode and the cathode have been permeated by oxygen, this indicates that hydrogen protection has been lost, and air has entered both sides of the FC.

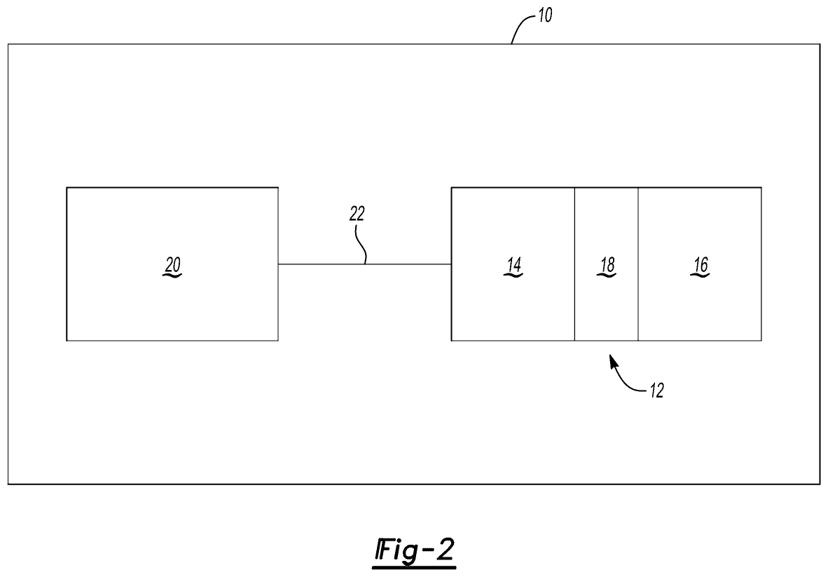

FIG. 2 is a schematic diagram of an automotive FC system 10. The automotive FC system 10 contains a FC 12, which includes an anode 14, a cathode 16, and a separator 18 positioned between the anode 14 and the cathode 16. The separator 18 may be a proton exchange membrane made of materials such as perfluoro sulfonic acid polymers. This separator 18 allows protons to pass through while blocking electrons and gases, which allows for the electrochemical reactions in the FC 12. The anode 14 and cathode 16 may be made of porous carbon materials coated with catalysts. For the anode 14, platinum or platinum-ruthenium alloys may be used as catalysts to facilitate the hydrogen oxidation reaction. The cathode 16 may use platinum or platinum-cobalt alloys to catalyze the oxygen reduction reaction. The FC 12 is coupled with a controller 20. This controller 20 manages the operations of the automotive FC system 10. The controller 20 is connected to the FC 12 via communication lines 22. These communication lines 22 enable the controller 20 to monitor various parameters of the FC 12 such as cell voltage, temperature, and gas pressures, and to control different aspects of the FC 12.

The controller 20 may be programmed to manage operations of the FC system 10. These operations include injecting H₂ into the anode 14 and purging oxygen from the cathode 16 based on predetermined conditions or time periods. The controller 20 may monitor voltage from the FC 12 during these processes and can terminate them when specific thresholds are reached, to maintain performance and longevity of the FC 12. The FC system 10 may include additional components such as an H₂ storage system, using high-pressure tanks or metal hydrides, connected to the anode 14 for supplying H₂. An air management system, including a compressor and possibly humidifiers, may be connected to the cathode 16 for oxygen supply and control. The configuration of the FC system 10 supports operations without the need for external connections to an electrical bus during H₂ maintenance procedures. This allows for greater flexibility in managing the state of the FC 12 during periods of inactivity, which preserves the integrity of catalyst layers and extends the overall lifespan of the FC 12. The controller 20 may also be programmed to base its operations on estimated hydrogen depletion rates of the FC 12. This allows for adaptive management of the FC system 10, considering factors such as temperature, pressure, and previous usage patterns to optimize the timing of hydrogen injection and oxygen purging procedures.

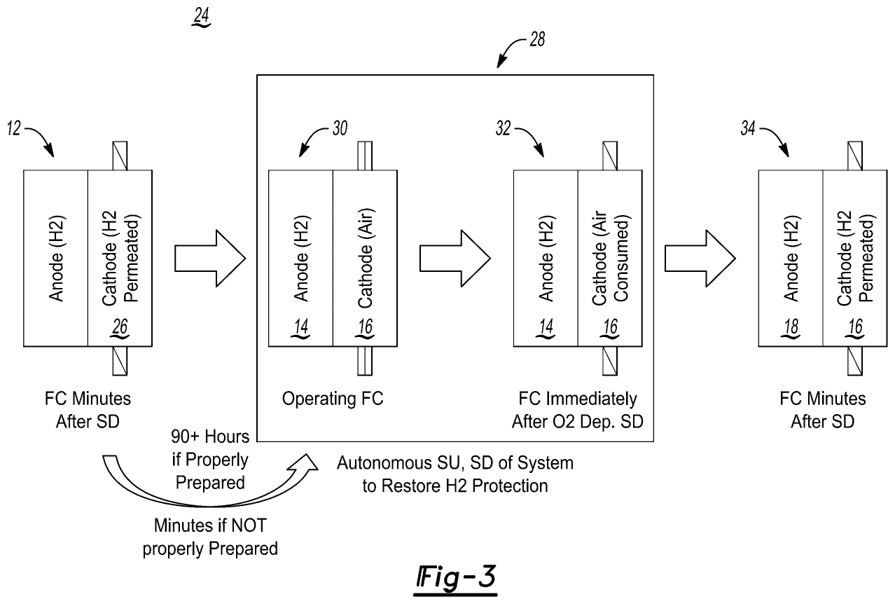

FIG. 3 is a schematic diagram of a H₂ mitigation system 24 for a FC. This H₂ mitigation system 24 begins with stage 26, labeled “FC minutes after SD,” which shows the FC 12 immediately after a SD procedure. In this state, both the anode 14 and the cathode 16 are filled with H₂. This state represents the initial hydrogen protection phase, where the FC is prepared for a period of inactivity. The H₂ mitigation system 24 has a process of autonomous start up (SU) and SD 28 to restore H₂ protection in the FC 12. Within the process of autonomous SU and SD 28, operation 30 labeled “Operating FC,” shows a SU with the FC 12 in its normal operating condition. The anode 14 is filled with H₂, while the cathode 16 is filled with air, representing the typical reactant distribution during operation of the FC 12. During SD operation 32 labeled “FC immediately after O₂ Dep. SD,” shows the FC 12 after an oxygen depletion SD. The anode 14 remains filled with H₂, while no oxygen remains in the cathode 16. After the process of autonomous SU and SD 28, H₂ from the anode 14 permeates across the separator 18 to the cathode 16. In this stage 34, both the anode 14 and the cathode 16 are again filled with hydrogen again for protection during inactivity. The process of autonomous SU and SD 28 may be repeated as necessary depending on the length of the period of inactivity to maintain the protective stage 34 of the FC 12 for extended periods.

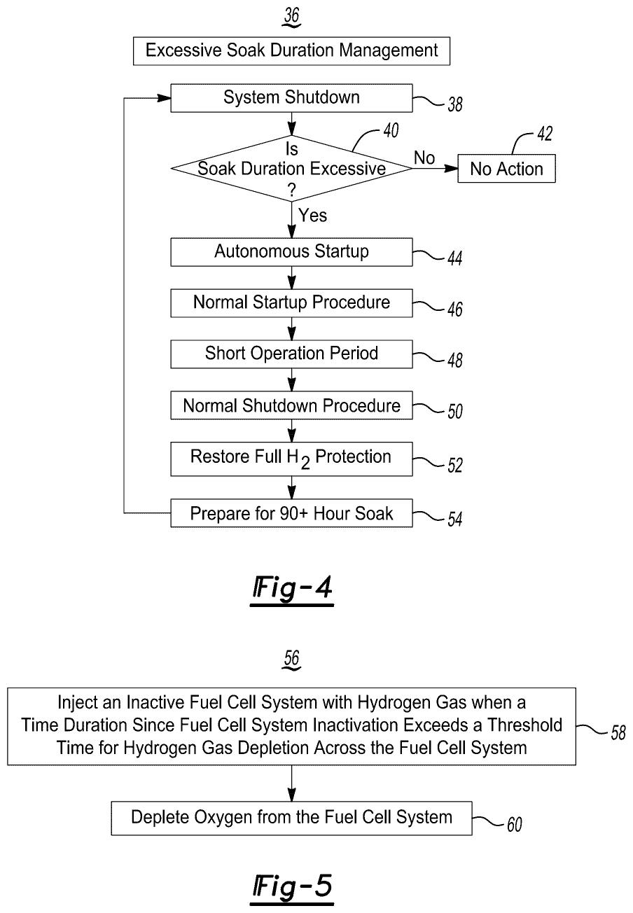

FIG. 4 is a process diagram of an excessive soak duration management system 36 for a FC system. The process begins with a system shutdown 38, which initiates the management sequence. Following shutdown, the system evaluates the soak duration at decision point 40, asking “If soak duration excessive?” This step determines whether the FC has been inactive for a period that may compromise its H₂ protection. If the soak duration is not excessive, the flowchart leads to no action 42, indicating that the current H₂ protection is sufficient, and no intervention is necessary.

However, if the soak duration is deemed excessive, the system proceeds to an autonomous startup 44. The autonomous startup 44 initiates a series of automated procedures configured to refresh the FC's H₂ protection. The autonomous startup 44 leads to a normal startup procedure 46, where the FC system goes through its standard initialization process without closing any electrical contacts with any taction components. This is followed by a short operation period 48, during which the FC briefly runs to restore H₂. After the short operation, the system executes a normal shutdown procedure 50. This controlled shutdown during the normal shutdown procedure 50 establishes proper conditions for extended inactivity by depleting oxygen. The next step, restore full H₂ protection 52, indicates that a protective environment for the FC components has been created, particularly the catalyst layers. Finally, the process concludes with prepare for 90+ hour soak 54. This step sets up the FC system for an extended period of inactivity, with the newly restored H₂ protection capable of maintaining integrity of the FC for over 90 hours. However, if the period of inactivity is deemed excessive the excessive soak duration management system 36 may return to decision point 40 for repetition.

FIG. 5 illustrates a flowchart of a method 56 for mitigating degradation in a FC system during extended periods of inactivity. The first step 58 involves injecting an inactive FC system with H₂ when a time duration since the inactivation of the FC system exceeds a threshold time for H₂ depletion across the FC system. This step 58 maintains the protective H₂ environment within the FC, preventing catalyst degradation that can occur when the fuel cell is exposed to air for extended periods. The second step 60 involves depleting oxygen from the FC system. This oxygen depletion process creates an inert environment within the FC, further protecting its components from degradation. In further configurations, the method 56 may involve monitoring voltage of the FC, adapting the threshold time based on prior operating conditions, and performing the method 56 periodically during extended inactivity. The H₂ injection might be accomplished using a connected storage system, while oxygen depletion could involve activating an air compressor to purge the system. This method 56 may potentially be applied more broadly to various types of electrochemical cells in various applications.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials. “Controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An automotive fuel cell system comprising:
a fuel cell including an anode, a cathode, and a membrane separating the anode and the cathode; and
a controller programmed to, responsive to expiration of a predetermined time period that begins with disconnection of the fuel cell from an electrical bus, inject hydrogen gas into the anode and purge the cathode of oxygen.

2. The automotive fuel cell system of claim 1 wherein the controller is further programmed to monitor a voltage of the fuel cell during hydrogen gas injection and oxygen purge.

3. The automotive fuel cell system of claim 2 wherein the controller is programmed to terminate the hydrogen gas injection and oxygen purge when the voltage reaches a predetermined threshold.

4. The automotive fuel cell system of claim 1 wherein the controller is programmed to perform the hydrogen gas injection and oxygen purge without a contactor to connect the fuel cell to the electrical bus engaged.

5. The automotive fuel cell system of claim 1 wherein the predetermined time period is based on an estimated hydrogen gas depletion rate of the fuel cell.

6. The automotive fuel cell system of claim 1, further comprising a hydrogen gas storage system connected to the anode for supplying the hydrogen gas.

7. The automotive fuel cell system of claim 1, further comprising an air compressor connected to the cathode for purging oxygen.

8. A method for mitigation in a fuel cell system comprising:
injecting an inactive fuel cell system with hydrogen gas when a time duration since fuel cell system inactivation exceeds a threshold time for hydrogen gas depletion across the fuel cell system; and
depleting oxygen from the fuel cell system.

9. The method of claim 8, further comprising monitoring a voltage of the fuel cell system during the injecting and depleting.

10. The method of claim 9, further comprising terminating the injecting and depleting when the voltage reaches a predetermined threshold.

11. The method of claim 8 wherein the threshold time is based on operating conditions of the fuel cell system prior to inactivation.

12. The method of claim 8, further comprising performing the injecting and depleting periodically while the fuel cell system remains inactive for an extended period.

13. The method of claim 8 wherein the injecting comprises supplying hydrogen gas from a hydrogen gas storage system connected to the fuel cell system.

14. The method of claim 8 wherein the depleting comprises activating an air compressor to purge oxygen from the fuel cell system.

15. A method comprising:
providing hydrogen gas to an inactive electrochemical cell anode when an elapsed time since deactivation of a corresponding electrochemical cell exceeds a predefined hydrogen gas depletion threshold, thereby reactivating the electrochemical cell; and
removing oxygen from the electrochemical cell to initiate an inactive state and reduce residual voltage for subsequent reactivation of the electrochemical cell.

16. The method of claim 15, further comprising monitoring a voltage of the electrochemical cell during the providing.

17. The method of claim 16, further comprising terminating the providing and removing when the voltage reaches a predetermined threshold.

18. The method of claim 15 wherein the predefined hydrogen gas depletion threshold is based on operating conditions of the electrochemical cell prior to the deactivation.

19. The method of claim 15, further comprising performing the providing and removing without connecting the electrochemical cell to an external load.

20. The method of claim 15 wherein the providing and removing are performed using a controller programmed to initiate the providing and removing based on the elapsed time since deactivation.
